(19) United States
(12) Patent Application Publication
(10) Pub. No.: US 2021/0192868 A1
(43) Pub. Date: Jun. 24, 2021

(54) TIRE POSITION IDENTIFICATION METHOD AND TIRE MONITORING SYSTEM PERFORMING THE SAME

(71) Applicant: SEETRON INC., Gyeonggi-do (KR)

(72) Inventors: Jae Seong HAN, SEOUL (KR); Hyun Seop LIM, Incheon (KR); Jae Sung SO, Gyeonggi-do (KR)

(73) Assignee: SEETRON INC., Gyeonggi-do (KR)

(21) Appl. No.: 17/088,673

(22) Filed: Nov. 4, 2020

(30) Foreign Application Priority Data
Nov. 4, 2019 (KR) 10-2019-0139652

(51) Int. Cl. G07C 5/02; B60C 19/00; G01P 15/00; G01P 3/00; G01B 21/22

(52) U.S. Cl. CPC G07C 5/02; B60C 19/00; G01P 15/00; B60T 17/22; G01B 21/22; B60C 2019/004; G01P 3/00

(57) ABSTRACT

A tire monitoring system may include: a state information collecting device installed in a first tire of a vehicle, and periodically transmitting unique identification information according to a rotation period of the first tire; a plurality of wheel speed sensors of which position information is changed according to rotations of a plurality of second tires installed in the vehicle; and a monitoring device for receiving the unique identification information from the state information collecting device, detecting position information of the respective wheel speed sensors according to a receiving time of the unique identification information for a predetermined time, and identifying a position of the first tire based on fluctuating patterns of position information of the respective wheel speed sensors detected according to the receiving time of the unique identification information.

### TECHNICAL FIELD

An embodiment of the present invention relates to a tire position identifying method and a tire monitoring system for performing the same.

### BACKGROUND ART

A tire pressure monitoring system (TPMS) is a device for detecting tire state information through various sensors installed in a tire of a vehicle, sensing pressures of respective tires, and maintaining the pressures of the tires at an appropriate level.

To perform a pressure maintaining function, the TPMS has to identify to which tire the state information received from the sensors relates.

Conventionally, to identify the tires, a method for assigning different kinds of identification information to wheels to which tires are installed, including corresponding wheel identification information in state information, and transmitting them is used. However, regarding the above-noted method, the wheel identification information is also changed when the tire is replaced, so the worker has to manually perform the process for registering new wheel identification information to the TPMS when the tire is replaced.

### DISCLOSURE

### Technical Problem

The present invention has been made in an effort to provide a tire position identifying method for automatically changing a tire and recognizing a position of the changed tire in a tire pressure monitoring system when a worker does not perform a process for registering an identification number of a new tire when the tire of the vehicle is changed, and a tire monitoring system for performing the method.

### Technical Solution

An embodiment of the present invention provides a tire monitoring system that may include: a state information collecting device installed in a first tire of a vehicle, and periodically transmitting unique identification information according to a rotation period of the first tire; a plurality of wheel speed sensors of which position information is changed according to rotations of a plurality of second tires installed in the vehicle; and a monitoring device for receiving the unique identification information from the state information collecting device, detecting position information of the respective wheel speed sensors according to a receiving time of the unique identification information for a predetermined time, and identifying a position of the first tire based on fluctuating patterns of position information of the respective wheel speed sensors detected according to the receiving time of the unique identification information.

The wheel speed sensors may respectively be a wheel speed sensor in an anti-lock brake system of the corresponding tire.

Position information of the respective wheel speed sensors may be relative angle information with reference to a reference point.

The state information collecting device may include a two-axis sensor installed in the first tire and generating a sensing signal corresponding to acceleration information of the first tire, the sensing signal may include an x-axis phase waveform and a z-axis phase waveform output from the two-axis sensor, and the acceleration information may include phase difference information between the x-axis phase waveform and the z-axis phase waveform.

An installing direction of the two-axis sensor may become different according to a position of the first tire, and the monitoring device may receive the acceleration information from the state information collecting device, may estimate a rotation direction of the first tire from the acceleration information, and may determine a position of the first tire based on the rotation direction of the first tire.

Regarding the two-axis sensor, an installing direction when the first tire corresponds to a left wheel may be opposite to an installing direction when the first tire corresponds to a right wheel, and an installing direction when the first tire corresponds to an inner wheel configuring dual wheels may be opposite to an installing direction when the first tire corresponds to an outer wheel configuring the dual wheels.

Regarding the rotation direction of the first tire estimated from the acceleration information while the vehicle goes in a first direction, a case in which the first tire corresponds to a left wheel and a case in which the first tire corresponds to a right wheel may be estimated to be in opposite directions to each other, and a case in which the first tire corresponds to an inner wheel configuring dual wheels and a case in which the first tire corresponds to an outer wheel configuring the dual wheels may be estimated to be in opposite directions to each other.

The monitoring device may calculate clustering degrees for the respective wheel speed sensors through a statistical analysis on position information of the respective wheel speed sensors detected according to a receiving time of the unique identification information, and may identify a position of the first tire based on the clustering degree and the tire positions defined for the wheel speed sensors.

The tire monitoring system may further include a receiving device for receiving a signal from a plurality of state information collecting devices including the state information collecting device in a wireless way, wherein the monitoring device may identify a position of the first tire based on signal receiving intensity in the receiving device for the state information collecting devices when the position of the first tire is not identified based on a fluctuating pattern of position information of the wheel speed sensors.

Another embodiment of the present invention provides a method for identifying a tire position of a tire monitoring system installed in a vehicle including: receiving unique identification information from a state information collecting device of the first tire according to a rotation period of a first tire installed in the vehicle; when receiving the unique identification information, detecting position information on a plurality of wheel speed sensors of which position information is changed according to respective rotations of a plurality of second tires installed in the vehicle; repeating the receiving of the unique identification information and the detecting of position information for a predetermined time: and identifying a position of the first tire based on a fluctuating pattern of position information detected for the respective wheel speed sensors for the predetermined time.

The wheel speed sensors may respectively be a wheel speed sensor in an anti-lock brake system of a corresponding tire, and position information of the respective wheel speed sensors may be relative angle information with reference to a reference point.

The method may further include: receiving acceleration information of the first tire detected from the state information collecting device through a two-axis sensor; estimating a rotation direction of the first tire based on the acceleration information; and identifying a position of the first tire based on the rotation direction, wherein an installing direction of the two-axis sensor may be changed according to a position of the first tire, and the rotation direction may be differently estimated according to an installing direction of the two-axis sensor.

Regarding the rotation direction, a case in which the first tire corresponds to a left wheel and a case in which the first tire corresponds to a right wheel may be estimated to be in opposite directions to each other, and a case in which the first tire corresponds to an inner wheel configuring dual wheels and a case in which the first tire corresponds to an outer wheel configuring the dual wheels may be estimated to be in opposite directions to each other.

The identifying may include: calculating clustering degrees for the respective wheel speed sensors through a statistical analysis on position information detected for the respective wheel speed sensors for the predetermined time; and identifying a position of the first tire based on the clustering degree and the tire positions defined for the respective wheel speed sensors.

The vehicle further includes a receiving device for receiving a signal from a plurality of state information collecting devices including the state information collecting device in a wireless way, and the method further includes when the position of the first tire is not identified based on a fluctuating pattern of position information of the respective wheel speed sensors, detecting signal receiving intensity in the receiving device for the state information collecting devices, and identifying a position of the first tire based on the signal receiving intensity in the receiving device for the respective state information collecting devices.

### Advantageous Effects

According to the embodiment of the present invention, it is possible to automatically change the tire and recognize the position of the changed tire in the tire pressure monitoring system when a worker does not perform the process for registering the identification number of the new tire when the tire of the vehicle is changed.

### BRIEF DESCRIPTION OF THE DRAWINGS

FIG. 1 shows a configurational diagram on a tire monitoring system according to an embodiment of the present invention.

FIG. 2A shows examples of a sensing signal output by a two-axis sensor of a tire monitoring system according to an embodiment of the present invention.

FIG. 2B shows an example in which a two-axis sensor of a tire monitoring system according to an embodiment of the present invention is installed in respective tires of a vehicle.

FIG. 3 shows an example of an assembly of a wheel speed sensor of a tire monitoring system according to an embodiment of the present invention.

FIG. 4 shows a flowchart on a method for identifying a tire position of a tire monitoring system according to an embodiment of the present invention.

FIG. 5A shows a flowchart of a method for identifying a tire position by using a position information fluctuating pattern of a wheel speed sensor in a tire monitoring system according to an embodiment of the present invention.

FIG. 5B shows a flowchart on correction of a clustering degree of FIG. 5A in detail.

FIG. 6A and FIG. 6B show examples in which a wheel speed sensor and a receiving device of a tire monitoring system according to an embodiment of the present invention are loaded in a vehicle.

FIG. 7 shows a flowchart on a method for identifying a tire position by using signal receiving intensity in a tire monitoring system according to an embodiment of the present invention.

FIG. 8 shows an example of a vehicle to which a tire monitoring system according to an embodiment of the present invention is applied, describing a method described with reference to FIG. 7.

FIG. 9 shows a flowchart on a method for identifying a tire position according to an automatic learning in a tire monitoring system according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Unless explicitly described to the contrary, the word “comprise” and variations such as “comprises” or “comprising” will be understood to imply the inclusion of stated elements but not the exclusion of any other elements.

A method for identifying a tire position and a tire monitoring system for performing the same will now be described with reference to accompanying drawings.

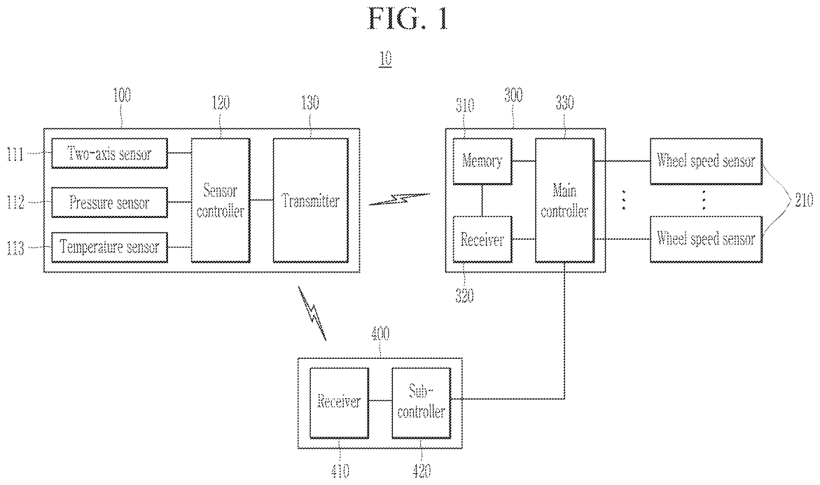

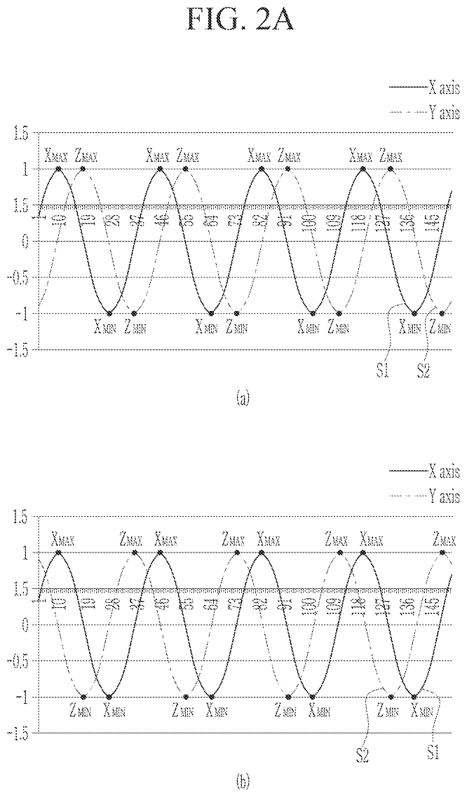

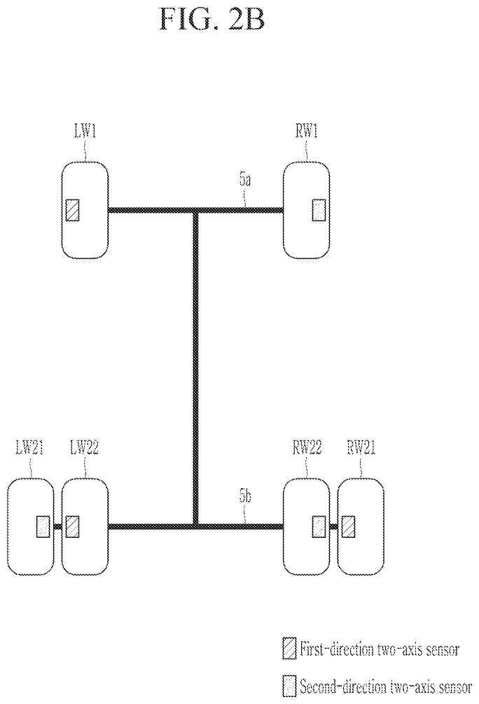

FIG. 1 shows a configurational diagram on a tire monitoring system according to an embodiment of the present invention. FIG. 2A shows examples of a sensing signal output by a two-axis sensor of a tire monitoring system according to an embodiment of the present invention, and FIG. 2B shows an example in which a two-axis sensor of a tire monitoring system according to an embodiment of the present invention is installed in respective tires of a vehicle.

Referring to FIG. 1, the tire monitoring system 10 may include a state information collecting device 100, a plurality of wheel speed sensors 210, and a monitoring device 300.

The state information collecting device 100 is installed for respective tires of the vehicle, and it may collect state information such as acceleration information, pressure information, and temperature information of the corresponding tire through at least one sensor and may transmit the state information to the monitoring device 300.

The state information collecting device 100 may include a two-axis sensor 111, a transmitter 130, and a sensor controller 120.

The two-axis sensor 111 is an acceleration sensor, and may be installed in the respective tires of the vehicle. The two-axis sensor 111 may measure acceleration of gravity of two axes, that is, a z axis and an x axis, applied to the corresponding tire when the tire rotates, and may output a corresponding sensing signal (or a voltage signal). Referring to FIG. 2A, the sensing signal output by the two-axis sensor 111 includes an x-axis phase waveform S1 and a z-axis phase waveform S2, and one period of the respective phase waveforms S1 and S2 may correspond to one rotation period of the corresponding tire.

The two-axis sensor 111 has different phase relationships between the z-axis phase waveform and the x-axis phase waveform included in the sensing signal, that is, phase differences, depending on installing directions. In FIG. 2A, (a) and (b) illustrate output signals of the two-axis sensors 111 with opposite installing directions. Referring to FIG. 2A, the phase relationship between the x-axis phase waveform and the z-axis phase waveform may be reversed with each other according to the installing direction.

In an embodiment, by using the above-noted characteristic of the two-axis sensor 111, different installing directions of the two-axis sensor 111 are provided to a left wheel and a right wheel installed in one axle, and an inner wheel and an outer wheel installed in one driving shaft, so the output of the two-axis sensor 111 is used in identification of the tire position. In the present specification, for ease of description, from among the two-axis sensors 111 installed in the opposite directions, the two-axis sensor 111 with the first direction as an installing direction will be referred to as a first direction two-axis sensor, and the two-axis sensor 111 with the second direction that is opposite to the first direction as an installing direction will be referred to as a second direction two-axis sensor.

For example with reference to FIG. 2B, from among front wheels connected to a same axle 5a, the first direction two-axis sensor 111 is installed in the left wheel LW1, and the second direction two-axis sensor 111 is installed in the right wheel RW1. Further, from among dual wheels installed as rear wheels, the first direction two-axis sensor and the second direction two-axis sensor are installed on the inner wheel LW22 and the outer wheel LW21 of the left dual wheels, the second direction two-axis sensor and the first direction two-axis sensor are installed on the inner wheel RW22 and the outer wheel RW21 of the right dual wheels. In another way, in the present specification, the dual wheels represent a state in which two wheels that are an inner wheel and an outer wheel are installed on one driving shaft, and a single wheel indicates a state that one wheel is installed on one driving shaft.

When receiving a sensing signal from the two-axis sensor 111, the sensor controller 120 may process the sensing signal into sensing information of the corresponding tire through signal processing such as an analog to digital (AD) conversion. The sensing information processed from the sensing signal of the two-axis sensor 111 is acceleration information of the corresponding tire, and it may include information showing a phase correlation (or a phase difference) between the x-axis phase waveform and the z-axis phase waveform included in the sensing signal of the two-axis sensor 111.

When obtaining sensing information (or acceleration information) from the output signal of the two-axis sensor 111, the sensor controller 120 transmits the sensing information and unique identification information (hereinafter, a sensor ID) assigned to the state information collecting device 100 to the monitoring device 300 through the transmitter 130. Particularly, when monitoring the sensing signal of the two-axis sensor 111 and sensing a rotation of the corresponding tire, the sensor controller 120 may transmit a sensor ID and sensing information acquired through the two-axis sensor 111, that is, acceleration information, to the monitoring device 300 for a predetermined period (e.g., 15 minutes) so as to identify the position of the corresponding tire. Here, the unique identification information (or a sensor ID) assigned to the state information collecting device 100 may be differently assigned for each state information collecting device 100 so as to identify the state information collecting device 100.

A transmission period for the sensor controller 120 to transmit the sensor ID and the acceleration information to the monitoring device 300 may be determined corresponding to one period of the x-axis phase waveform (or the z-axis phase waveform) included in the sensing signal of the two-axis sensor 111. One period of the x-axis phase waveform and the z-axis phase waveform output by the two-axis sensor 111 corresponds to one rotation period of the tire. For example with reference to FIG. 2A, repetition periods of points ZMAX and ZMIN in the z-axis phase waveform, and points XMAX and XMIN in the x-axis phase waveform, correspond to one rotation period of the tire. Therefore, the sensor controller 120 may transmit the sensor ID and the acceleration information to the monitoring device 300 corresponding to one rotation period of the tire by determining a transmission time of the sensor ID and the acceleration information from a detection time of the point XMAX or the point XMIN (or the point ZMAX or the point ZMIN of the z-axis phase waveform) of the x-axis phase waveform. However, the technical scope of the present invention is not limited thereto, and the sensor controller 120 may transmit the sensor ID and the acceleration information to the monitoring device 300 corresponding to the period of two rotations or the period of three rotations of the tire.

In addition, pressure information and temperature information of the tire are additionally needed as well as the acceleration information of the tire so that the monitoring device 300 may monitor a pressure state of the tire. For example, an internal temperature of the tire may be used to compensate a pressure increasing phenomenon with respect to the temperature of the tire. Therefore, the state information collecting device 100 may additionally include various sensors such as a pressure sensor 112 or a temperature sensor 113, and may collect various types of sensing information indicating state information of the corresponding tire. The collected tire state information may be periodically transmitted to the monitoring device 300 through the transmitter 130.

The transmitter 130 is a wireless transmitter, and it wirelessly transmits various kinds of information according to a control by the sensor controller 120.

A plurality of wheel speed sensors 210 are respectively installed in the corresponding tire (or a wheel), and may be used to detect the rotation speed of the corresponding tire (or the wheel rotation speed). The wheel speed sensor 210 periodically outputs position information of the wheel speed sensor 210, and the position information of the wheel speed sensor 210 may include relative angle information on how much angle the wheel speed sensor 210 is rotated and is then positioned with respect to a reference point.

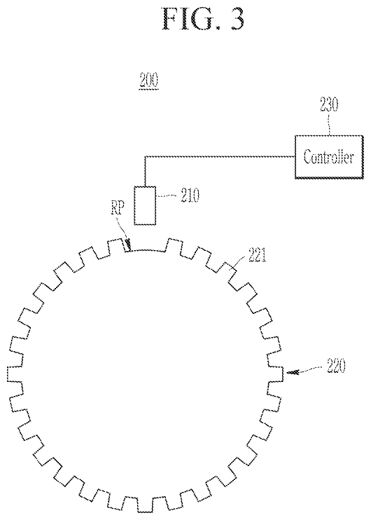

FIG. 3 shows an example of an assembly of a wheel speed sensor according to an embodiment of the present invention.

Referring to FIG. 3, the wheel speed sensor assembly 200 may include a wheel speed sensor 210, a sensor ring 220, and a controller 230.

The sensor ring 220 is installed to be rotated according to the rotation of the corresponding tire (or the wheel), and includes protrusions 221 in a sawtooth form protruding in a radial way. The protrusions 221 of the sensor ring 220 are disposed at regular intervals along an external circumferential surface of the sensor ring 220, and a protrusion at a specific point may be omitted so as to designate a reference point (RP) that becomes a reference for determining the rotation position.

The wheel speed sensor 210 is fixed to a position spaced from the protrusions 221 of the sensor ring 220 by a predetermined gap, and it may generate a corresponding pulse signal each time the protrusions 221 pass the wheel speed sensor 210 by the rotation of the sensor ring 220. Therefore, the controller 230 may estimate position information of the wheel speed sensor 210 by analyzing the pulse signal output by the wheel speed sensor 210. That is, the controller 230 may analyze a pulse gap of the pulse signal output by the wheel speed sensor 210 to detect a time when the reference point (RP) of the sensor ring 220 passes the wheel speed sensor 210, and may estimate position information of the wheel speed sensor 210 for indicating at how much rotated angle the wheel speed sensor 210 is positioned with respect to the reference point (RP) from the number of pulses that are generated after the reference point (RP) passes the wheel speed sensor 210.

When the position information of the wheel speed sensor 210 is estimated, the controller 230 may transmit the position information to the monitoring device 300 by using a communication method such as the controller area network (CAN) or the local interconnect network (LIN).

The above-described wheel speed sensor assembly 200 may be realized in an anti-lock brake system (ABS). The ABS is a brake system for preventing the wheel from being locked in the case of sudden braking of a vehicle, and it includes at least one wheel speed sensor for detecting the rotation speed of the corresponding wheel. Therefore, when the wheel speed sensor assembly 200 is realized in the ABS, the wheel speed sensor in the ABS may be used as a wheel speed sensor 210, and the ABS controller may perform a function of the controller 230.

In another way, the monitoring device 300 to be described matches the state information collecting device 100 and the wheel speed sensor 210 by using position information of the wheel speed sensor 210, and identifies the tire position of the corresponding state information collecting device 100 based on the position information of the tire in which the wheel speed sensor 210 is installed. The tire position information of the wheel speed sensor 210 is preset when the wheel speed sensor assembly 200 is installed, and the controller 230 may transmit it to the monitoring device 300 through the CAN or LIN communication.

Referring to FIG. 1, the monitoring device 300 analyzes the tire state information received from the state information collecting device 100 and monitors the pressure states of the respective tires, and it may include a receiver 310, a memory 320, and a main controller 330.

The receiver 310 is a wireless receiver, and it may wirelessly receive various types of information from the state information collecting devices 100.

The memory 320 may temporarily store data input/output by the monitoring device 300. For example, the memory 320 may map the tire position on the corresponding sensor ID of each state information collecting device 100 and may store the same. For example, the memory 320 may map various kinds of tire state information (acceleration information, pressure information, temperature information, etc.,) received from the state information collecting device 100 on the sensor ID and may store the same. For example, the memory 320 may map tire position information on each corresponding wheel speed sensor 210 and may store the same. For example, the memory 320 may map position information received from the corresponding wheel speed sensor 210 on each wheel speed sensor 210 and may store the same

To analyze the state information received from each state information collecting device 100 and know the states of the tires, the monitoring device 300 needs to recognize the tire position (front left, front right, rear left, rear right, outer wheel, inner wheel, etc.) corresponding to each state information collecting device 100. Therefore, before monitoring the tire state, the main controller 330 performs a process for automatically identifying the tire position corresponding to each state information collecting device 100.

As described about each state information collecting device 100, the period for the state information collecting device 100 to transmit the acceleration information and the sensor ID so as to identify the position of the corresponding tire depends on the rotation period of the corresponding tire. The position information of the wheel speed sensor 210 is changed according to the rotation period of the tire. Therefore, regarding position information of each wheel speed sensor 210, it is very probable that similar position information is detected each time the sensor ID is received from the state information collecting device 100 installed in the same tire.

By using this principle, the main controller 330 detects position information of each wheel speed sensor 210 each time receiving acceleration information and a sensor ID for identifying tire position from the state information collecting device 100, it specifies wheel speed sensors 210 with small statistic distribution values by analyzing position information of the wheel speed sensor 210 detected for a predetermined time, so it may match the tire position and each state information collecting device 100.

In another way, when the vehicle performs the process for identifying a tire position while maintaining a straight drive, the tires connected to one axle may rotate with similar rotation periods. For example with reference to FIG. 2B, the left wheel LW1 and the right wheel RW1 installed on the first axle 5a rotate with similar rotation periods when the vehicle drives straight, so position information of the wheel speed sensors 210 installed in the left wheel LW1 and the right wheel RW1 may be changed with similar periods. Therefore, during the process for identifying the tire position of the state information collecting device 100 installed in the left wheel LW1 or the right wheel RW1 installed in the first axle 5a by using position information of the wheel speed sensors 210, the wheel speed sensors 210 installed in the left wheel LW1 and the right wheel RW1 may be recognized as matched wheel speed sensors. Accordingly, in an embodiment, the installing directions of the two-axis sensors 111 are set to be opposite to each other on the front wheel and the right wheel (e.g., the left wheel LW1 and the right wheel RW1) installed in the same axle 5a, and the main controller 330 may identify the tire position by using that the two-axis sensors 111 of the front wheel and the right wheel installed on the same axle output acceleration information of which a phase difference between the x-axis and z-axis phase waveforms is reversed.

Further, in the case of the dual wheels, the inner wheel and the outer wheel are rotated in conjunction with the same driving shaft. Therefore, during the process for identifying the tire position of the state information collecting device 100 of the inner wheel or the outer wheel by using position information of the wheel speed sensors 210, the wheel speed sensors 210 of the inner wheel and the outer wheel may be recognized as matched wheel speed sensors. Therefore, in an embodiment, the installing directions of the two-axis sensors 111 are set to be opposite to each other on the inner wheel and the outer wheel installed in the same driving shaft, and the main controller 330 may identify the tire position by using that the two-axis sensors 111 of the inner wheel and the outer wheel installed on the same driving shaft output acceleration information of which a phase difference between the x-axis and z-axis phase waveforms is reversed.

As described with reference to FIG. 2A, the x-axis and z-axis phase waveforms output from the two-axis sensors 111 installed in the opposite directions show reversed phase differences. Therefore, when the acceleration information is obtained by using the two-axis sensors 111 installed in the opposite directions on the same tire, the rotation directions of the tire indicated by the two types of acceleration information are shown to be opposite to each other. Therefore, the main controller 330 may estimate the rotation direction of the tire by analyzing acceleration information (a phase correlation between the x-axis and z-axis phase waveforms) received from the state information collecting device 100, and it may use the acceleration information to distinguish the front wheel and the right wheel installed in the same axle, or the outer wheel and the inner wheel installed in one driving shaft. In this instance, each time of receiving acceleration information from the state information collecting device 100, the main controller 330 estimates the rotation direction of the tire from the acceleration information, and when the estimated rotation direction of the tire is sequentially identically provided a predetermined number of times, it finally determines the rotation direction of the tire in which each state information collecting device 100 is installed.

Further, as described above, the method for identifying the tire position by an analysis on a position information fluctuating pattern of the wheel speed sensor 210 has a problem that it may only identify the tire in which the wheel speed sensor 210 is installed. Therefore, the tire monitoring system 10 may further include at least one receiving device 400 when there is a tire in which no wheel speed sensor 210 is installed, and it may further perform a process for identifying a tire position by using signal receiving intensity for receiving a wireless signal from each state information collecting device 100 by the receiving device 400. For this purpose, the receiving device 400 may include a receiver 410 for receiving a wireless signal from the state information collecting device 100, and a sub-controller 420 for detecting signal receiving intensity of the received signals through the receiver 410.

When receiving a signal from each state information collecting device 100, the sub-controller 420 may detect signal receiving intensity of the state information collecting device 100. The sub-controller 420 may transmit the sensor ID received from the state information collecting device 100 and the signal receiving intensity of the state information collecting device 100 to the main controller 330 through the CAN or LIN communication.

The receiving device 400 may be disposed near one of the tires in which the wheel speed sensor 210 is not installed. The signal receiving intensity of the receiving device 400 becomes different depending on a distance between the receiving device 400 and the state information collecting device 100. Therefore, when receiving the signal receiving intensity and the sensor ID corresponding to it from the receiving device 400, the main controller 330 may arrange the sensor IDs in descending order of the signal receiving intensities, and may match the tire positions and the respective sensor IDs by using the arranging order of the sensor IDs and a distance between the receiving device 400 and the tires. For example, the state information collecting device 100 with the strongest signal receiving intensity in the receiving device 400 may be considered to be installed in the tire that is the nearest the receiving device 400, so the position of the tire that is the nearest the receiving device 400 may match the sensor ID of the corresponding state information collecting device 100.

In another way, in a like manner of identifying the tire position by using the position information changing pattern of the wheel speed sensor 210, when identifying the tire position based on the signal receiving intensity, the main controller 330 may distinguish the tires connected to the same axle or the outer wheel and the inner wheel configuring one dual wheel by analyzing the tire rotation direction estimated from the acceleration information received from each state information collecting device 100.

As described above, when identification of the tire position on the respective state information collecting devices 100 is finished by using the position information fluctuating pattern of the wheel speed sensor 210, the rotation directions of the respective tires estimated by use of the two-axis sensor 111, and the signal receiving intensity of the receiving device 400, the main controller 330 maps the sensor ID of the state information collecting device 100 on the respective tire positions and stores results in the memory 320.

When the process for matching the state information collecting device 100 and the tire position is finished, the main controller 330 may periodically receive tire state information (acceleration information, pressure information, temperature information, etc.,) from the state information collecting device 100 through the receiver 310, and may monitor pressure states of the respective tires.

In addition, FIG. 1 exemplifies the case in which one monitoring device 300 receives signals from the state information collecting devices 100 and processes the signals, and the technical idea of the present invention is not limited hereto. A big vehicle has a long distance between tires, so when state information is received from all the state information collecting devices 100 by using the monitoring device 300 fixed to one place, information transmitted by the state information collecting device 100 that is distant from the monitoring device 300 may not be properly received. Therefore, in another embodiment, the monitoring device 300 may be additionally installed in the vehicle if needed, and the state information transmitted from the state information collecting devices 100 may be received in a divided way through the additionally installed monitoring device 300.

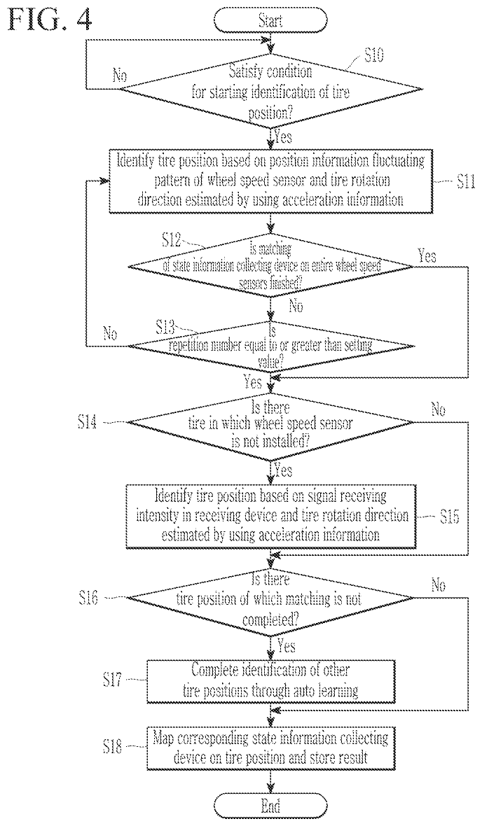

A method for identifying a tire position according to an embodiment of the present invention will now be described with reference to FIG. 4.

FIG. 4 shows a flowchart on a method for identifying a tire position according to an embodiment of the present invention, and the method for identifying a tire position described with reference to FIG. 4 may be performed by a main controller 330 of a tire monitoring system 10 described with reference to FIG. 1.

Referring to FIG. 4, when a condition for starting an identification of the tire position is satisfied (S10), the main controller 330 of the tire monitoring system 10 according to an embodiment of the present invention identifies the tire position based on the tire rotation direction estimated by using the position information fluctuating pattern of the wheel speed sensor 210 for a predetermined time, and the acceleration information received from the state information collecting devices 100 (S11).

In S10, the main controller 330 may determine as that the condition for starting an identification of the tire position is satisfied when the tire is sensed to rotate while the vehicle starts the engine and the transmission is not set as reverse.

In S10, the main controller 330 may determine that the condition for starting an identification of the tire position is satisfied when receiving the sensor ID of a new state information collecting device 100 that is not registered to the tire monitoring system 10 for more than a predetermined time.

The period for each state information collecting device 100 to transmit the acceleration information and the sensor ID for the purpose of identifying the tire position depends on the rotation period of the corresponding tire, and the position information fluctuating pattern of the wheel speed sensor 210 also depends on the rotation period of the corresponding tire. Therefore, in S11, each time receiving the sensor ID for identifying the tire position from each state information collecting device 100, the main controller 330 may detect position information of each wheel speed sensor 210 for a predetermined time, may perform a statistical analysis on the position information of the wheel speed sensors 210 detected for a predetermined time corresponding to receiving of the sensor ID, and accordingly may match each state information collecting device 100 and the wheel speed sensor 210. Regarding the state information collecting device 100 matching each wheel speed sensor 210, the tire position may be identified by referring to the tire position information predefined on the wheel speed sensor 210.

In S11, the main controller 330 may analyze acceleration information (a phase correlation between the x-axis and z-axis phase waveforms) received from each state information collecting device 100 to determine the rotation direction of the tire corresponding to each state information collecting device 100, and may use it to distinguish the tires connected to the same axle, or the outer wheel and the inner wheel configuring one set of dual wheels.

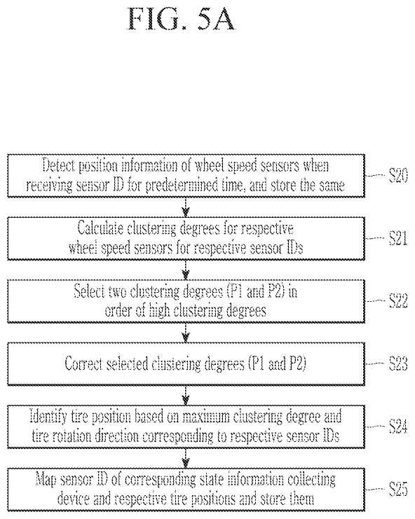

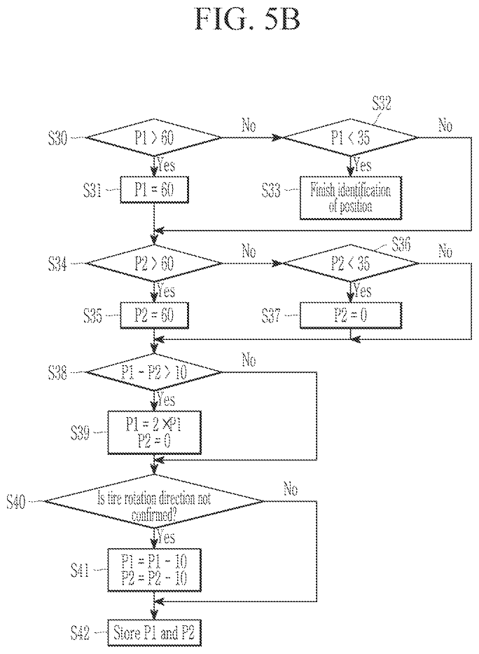

In S11, the method for identifying a tire position by using the position information fluctuating pattern of the wheel speed sensor 210 and the tire rotation direction corresponding to each state information collecting device 100 will be described in detail with reference to FIG. 5A and FIG. 5B.

Referring to FIG. 4, the main controller 330 having performed the identifying of a tire position through S11 determines whether matching of the state information collecting device 100 on the wheel speed sensors 210 is completed (S12). That is, the main controller 330 determines whether the corresponding state information collecting device 100 on the entire tire positions in which the wheel speed sensor 210 is installed is identified.

The main controller 330 finishes the process for identifying a tire position using the position information fluctuating pattern of the wheel speed sensor 210 when the matching of the state information collecting device 100 on the wheel speed sensors 210 is finished in S12, or when a repetition number of the process for identifying a tire position using the position information fluctuating pattern of the wheel speed sensor 210 (S11) is equal to or greater than a setting value (e.g., three times) (S13).

On the contrary, the main controller 330 repeatedly performs the step S11 when the repetition number of the process for identifying a tire position S11 is less than the setting value (e.g., three times) while the matching of the state information collecting device 100 on at least some tires in which the wheel speed sensor 210 is not completed.

The method for identifying a tire position using a position information fluctuating pattern of the wheel speed sensor 210 is allowable on the tire in which the wheel speed sensor 210 is installed. Therefore, when there is a tire in which the wheel speed sensor 210 is not installed (S14), the main controller 330 additionally performs the process for identifying a tire position based on the signal receiving intensity on each state information collecting device 100 in the receiving device 400, and the tire rotation direction estimated by using the acceleration information received from each state information collecting device 100 (S15).

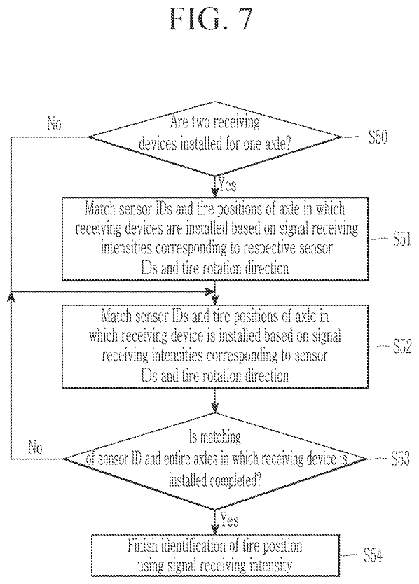

In S15, the receiving device 400 measures signal receiving intensity of the wireless signal received from the state information collecting device 100, and transmits the measured signal receiving intensity and a corresponding sensor ID to the main controller 330. The main controller 330 having received them may arrange the sensor IDs failing to identify corresponding tire positions in order of signal receiving intensities through S11, and may match the tire positions and the respective sensor IDs based on the arranged order and the distance between the receiving device 400 and the respective tires. In S15, a method for identifying a tire position based on the signal receiving intensity of each state information collecting device 100 in the receiving device 400, and the tire rotation direction estimated from the acceleration information received from each state information collecting device 100, will be described in detail with reference to FIG. 7.

In addition, when the matching of the corresponding state information collecting device 100 on some tire positions is not completed after the process is performed up to S15 (S16), the main controller 330 finishes the identification of a tire position, through auto learning, regarding the tire position of which the matching with the state information collecting device 100 is not completed (S17).

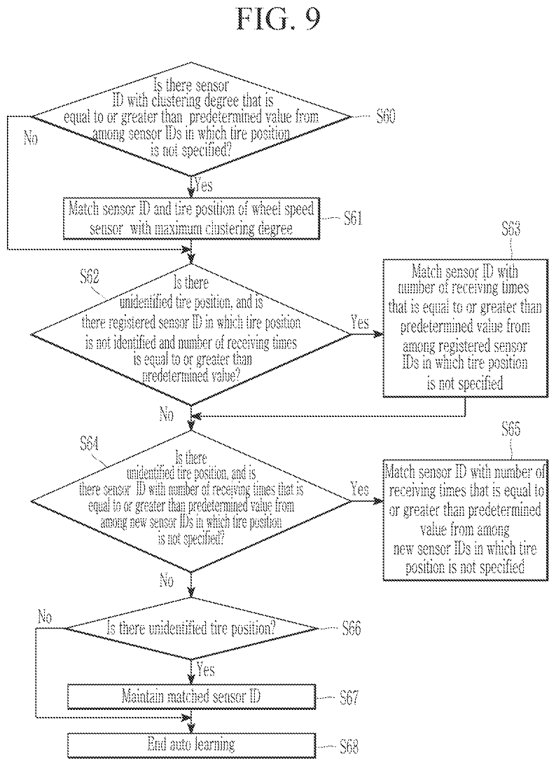

The method for identifying a tire position through auto learning in S17 will be described in detail with reference to FIG. 9 to be described.

When the matching of the state information collecting device 100 on the entire tire positions is completed through S10 to S17, the main controller 330 maps the corresponding state information collecting device 100 on each tire position and stores a result in the memory 320 (S18). That is, the main controller 330 maps the corresponding sensor ID of the state information collecting device 100 on each tire position and stores a result in the memory 320.

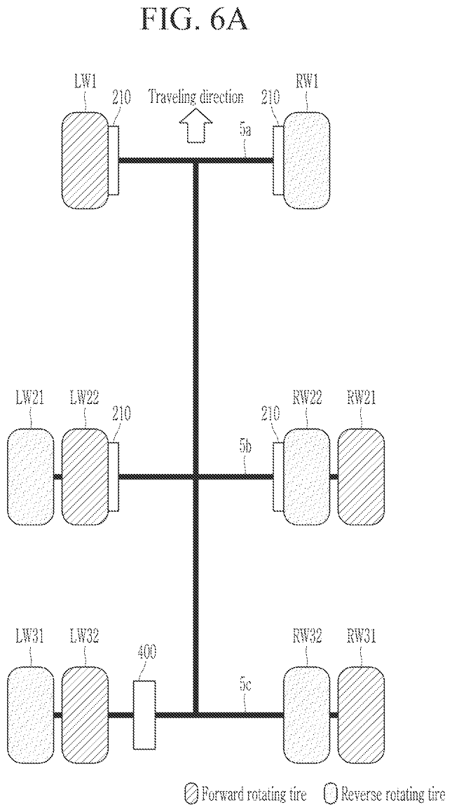

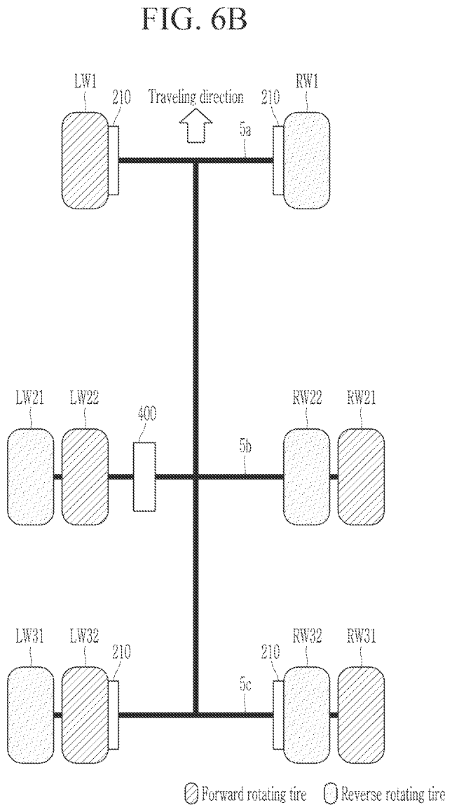

FIG. 5A shows a flowchart of a method for identifying a tire position by using a position information fluctuating pattern of a wheel speed sensor in a tire monitoring system according to an embodiment of the present invention. FIG. 5B shows a flowchart illustrating in detail a correction of a clustering degree of FIG. 5A. FIG. 6A and FIG. 6B show examples in which a wheel speed sensor and a receiving device of a tire monitoring system according to an embodiment of the present invention are loaded in a vehicle.

Referring to FIG. 5A, the main controller 330 of the tire monitoring system 10 according to an embodiment of the present invention receives acceleration information and a sensor ID from the state information collecting devices 100 for a predetermined time so as to identify the tire position. Each time receiving the sensor ID from the state information collecting devices 100, the main controller 330 detects position information of each wheel speed sensor 210, and stores it in the memory 320 (S20).

In S20, the period for detecting the position information of each wheel speed sensor 210 may be set to be a period from a time of starting detection of position information to when a predetermined time passes.

In S20, the period for detecting position information of each wheel speed sensor 210 may be set to be a period until the number of sensor IDs in which the total number of receiving is equal to or greater than the setting value becomes equal to or greater than a threshold value.

Further, when the transmission of the vehicle is changed into the reverse state, the main controller 330 may delete the position information of the wheel speed sensor 210 detect through S20, and may stop the process for identifying a tire position.

In S20, when position information is detected from the wheel speed sensor 210, the main controller 330 may store it in the memory 320, or may convert the position information of each wheel speed sensor 210 into an accumulated histogram form expressed in Table 1 and may store a result so as to efficiently use the memory 320.

Table 1 exemplifies an accumulated histogram in which position information of the wheel speed sensor 210 detected for each receiving time of a specific sensor ID is accumulated and counted according to the tire position of the wheel speed sensor 210 corresponding to the group to which each position information belongs.

TABLE 1
Example of accumulated histogram

Accumulated counts

| Groups | Front left | Front right | Rear left | Rear right |
|---|---|---|---|---|
| 0-3 | 6 | 6 | 2 | 2 |
| 4-7 | 3 | 4 | 3 | 2 |
| 8-11 | 4 | 8 | 4 | 4 |
| 12-15 | 1 | 3 | 7 | 4 |
| 16-19 | 4 | 3 | 7 | 5 |
| 20-23 | 1 | 2 | 8 | 4 |
| 24-27 | 4 | 5 | 10 | 4 |
| 28-31 | 2 | 2 | 12 | 5 |
| 32-35 | 3 | 0 | 9 | 4 |
| 36-39 | 5 | 8 | 3 | 2 |
| 40-43 | 2 | 1 | 3 | 6 |
| 44-47 | 8 | 5 | 1 | 3 |
| 48-51 | 5 | 3 | 0 | 5 |
| 52-55 | 1 | 2 | 0 | 4 |
| 56-59 | 3 | 0 | 0 | 5 |
| 60-63 | 3 | 4 | 0 | 2 |
| 64-67 | 4 | 0 | 0 | 4 |
| 68-71 | 5 | 5 | 0 | 3 |
| 72-75 | 6 | 7 | 1 | 2 |
| 76-79 | 2 | 4 | 2 | 2 |
| Sum | 72 | 72 | 72 | 72 |

As shown in FIG. 3, resolution of position information may be determined by the number of the protrusions 221 formed on the sensor ring 220 according to a structural characteristic of the wheel speed sensor assembly 200. For example, the wheel speed sensor assembly 200 from which the protrusions of the reference point (RP) are omitted and in which the sensor ring 220 is formed to have seventy nine protrusions 221, may output eighty position information values. However, in an embodiment, as expressed in Table 1, to use the memory 320 with efficiency, the eighty position information values are grouped by fours to classify twenty groups (sections), and an accumulated histogram in which position information of the wheel speed sensor 210 is accumulated and counted for respective groups is used. Regarding Table 1, front left, front right, rear left, and rear right respectively indicate positions of the tire in which the wheel speed sensor 210 is installed.

Referring to FIG. 5A and FIG. 5B, the main controller 330 calculates data clustering degrees for the respective wheel speed sensors 210 corresponding to the sensor ID of each state information collecting device 100 by using position information of the wheel speed sensor 210 detected for a predetermined time through S20 (S21).

The data clustering degree in S21 is a value, expressed in percentage, obtained by summing position information accumulated counts on N-numbered (e.g., five) sequential groups from among the groups for classifying position information values of the wheel speed sensor 210, and dividing the value by the receiving number of times of the corresponding sensor IDs.

Table 2 shows an example of a clustering degree calculated from Table 1.

TABLE 2
Example of clustering degrees

| Accumulated | Accumulated counts | | | |
|---|---|---|---|---|
| groups | Front left | Front right | Rear left | Rear right |
| #1 0-19 | 18 | 24 | 23 | 17 |
| #2 4-23 | 13 | 20 | 29 | 19 |
| #3 8-27 | 14 | 21 | 36 | 21 |
| #4 12-31 | 12 | 15 | 44 | 22 |
| #5 16-35 | 14 | 12 | 46 | 22 |
| #6 20-39 | 15 | 17 | 42 | 19 |
| #7 24-43 | 16 | 16 | 37 | 21 |
| #8 28-47 | 20 | 16 | 28 | 20 |
| #9 32-51 | 23 | 17 | 16 | 20 |
| #10 36-55 | 21 | 19 | 7 | 20 |
| #11 40-59 | 19 | 11 | 4 | 23 |
| #12 44-63 | 20 | 14 | 1 | 19 |
| #13 48-67 | 16 | 9 | 0 | 20 |
| #14 52-71 | 16 | 11 | 0 | 18 |
| #15 56-75 | 21 | 16 | 1 | 16 |
| #16 60-79 | 20 | 20 | 3 | 13 |
| #17 (64-79, 0-3) | 23 | 22 | 5 | 13 |
| #18 (68-79, 0-7) | 22 | 26 | 8 | 11 |
| #19 (72-79, 0-11) | 21 | 29 | 12 | 12 |
| #20 (76-79, 0-15) | 16 | 25 | 18 | 14 |
| Maximum accumulated | 23 | 29 | 46 | 23 |
| counts | | | | |
| Clustering degrees | 32% | 40% | 64% | 32% |

Referring to Table 2, the main controller 330 sums the position information accumulated counts of the five sequential groups and calculates the accumulated counts for the respective accumulated groups (#1 to #20). For example, regarding the accumulated group #1, the accumulated counts of the groups 0 to 3 to the groups 16 to 19 in Table 1 may be summed for the respective tire positions defined for the respective wheel speed sensors 210 and may then be mapped, and regarding the accumulated group #20, the accumulated counts of the groups 76 to 79 and the groups 0 to 3 to the groups 12 to 15 in Table 1 may be summed for the respective tire positions defined for the wheel speed sensor 210 and may then be mapped. When the accumulated counts are mapped for the respective accumulated groups, the main controller 330 selects the maximum accumulated counts for the respective tire positions defined for the respective wheel speed sensors 210, and uses them to calculate the clustering degrees for the respective wheel speed sensors 210. For example, when the tire position of the wheel speed sensor 210 is the front left wheel, the maximum accumulated count is 23, and the clustering degree calculate therefrom is 23/72×100=32%.

When the clustering degrees for respective wheel speed sensors 210 (or the clustering degrees for respective tire positions) are calculated for the respective sensor IDs through the above-described method, the main controller 330 selects two clustering degrees P1 in order of high clustering degrees, that is, in order of small distribution values for the respective sensor IDs (S22). That is, for the respective sensor IDs, the maximum clustering degree P1 and the second highest clustering degree P2 are selected from among the clustering degrees for respective wheel speed sensors 210. For example with Table 2, the main controller 330 may select the clustering degree of 64% of the wheel speed sensor 210 positioned on the rear left wheel and the clustering degree of 40% of the wheel speed sensor 210 positioned on the front right wheel from among the clustering degrees for respective wheel speed sensors 210.

When selection of the clustering degrees P1 and P2 is completed, the main controller 330 corrects the selected clustering degrees P1 and P2 (S23). A process for correcting the selected clustering degrees P1 and P2 for the respective sensor IDs will now be described with reference to FIG. 5B, FIG. 6A, and FIG. 6B. FIG. 6A and FIG. 6B show examples of a vehicle on which a wheel speed sensor 210 and a receiving device 400 according to an embodiment of the present invention are loaded.

Referring to FIG. 5B, the main controller 330 limits the corresponding clustering degree (P1 or P2) by 60% and corrects it (S31 and S35) for the clustering degree that is greater than 60% from among the clustering degrees P1 and P2 selected for the respective sensor IDs (S30 and S34).

On the contrary, when the clustering degree P1 is less than 35% (S32), the main controller 330 stops identification of the tire position using a clustering degree for the corresponding sensor ID (S33).

Further, when the clustering degree P2 is less than 35% (S36), the main controller 330 corrects P2 as 0 (S37), and identifies the tire position using a clustering degree by using the clustering degree P1.

When the clustering degrees P1 and P2 are respectively equal to or greater than 35% and it is given that P1−P2>10% (S38), the main controller 330 corrects P1 to be P1×2 that is double of P1 and corrects P2 to be 0 (S39) so as to improve discrimination.

On the contrary, when the clustering degrees P1 and P2 are equal to or greater than 35% and it is given that P1−P2=<10% (S38), the main controller 330 does not select one of the clustering degrees P1 and P2 for the corresponding sensor ID, but uses the clustering degrees P1 and P2 to identification of tire positions.

When the tire rotation direction for the corresponding sensor ID is not yet finally determined (S40), the main controller 330 reduces the respective clustering degrees P1 and P2 by 10 and corrects them (S41).

When the above-described correction is completed, the main controller 330 may store the corrected clustering degrees for respective wheel speed sensors 210 for the respective sensor IDs in the memory 320.

Table 3 and Table 4 express before and after correction of clustering degrees for respective wheel speed sensors 210 regarding the sensor ID of each state information collecting device 100 installed in the vehicle shown in FIG. 6A.

TABLE 3
Clustering degrees before correction

Clustering degrees

| Sensor | Rotation | Front | Front | Rear | Rear |
|---|---|---|---|---|---|
| ID | direction | left | right | right | left |
| A001 | Forward | 65 | 40 | 0 | 0 |
| A002 | Reverse | 25 | 50 | 0 | 0 |
| A003 | Forward | 10 | 0 | 55 | 0 |
| A004 | Reverse | 0 | 0 | 40 | 30 |
| A005 | Forward | 0 | 0 | 35 | 60 |
| A006 | Reverse | 0 | 0 | 35 | 30 |
| A007 | Forward | 0 | 0 | 40 | 37 |
| A008 | Reverse | 0 | 0 | 60 | 30 |
| A009 | Forward | 35 | 0 | 40 | 0 |
| A009 | Reverse | 0 | 25 | 0 | 55 |

TABLE 4
Clustering degrees after correction

| | | Clustering degrees | | | | | |
|---|---|---|---|---|---|---|---|
| Sensor | Rotation | Front | Front | Rear | Rear | | Position |
| ID | direction | left | right | right | left | RSSI | identification |
| A001 | Forward | 120 | 0 | 0 | 0 | 40 | One-axis left |
| | | | | | | | wheel |
| A002 | Reverse | 0 | 100 | 0 | 0 | 30 | One-axis right |
| | | | | | | | wheel |
| A003 | Forward | 0 | 0 | 110 | 0 | 70 | Two-axis left |
| | | | | | | | inner wheel |
| A004 | Reverse | 0 | 0 | 80 | 0 | 65 | Unidentified |
| A005 | Forward | 0 | 0 | 0 | 120 | 55 | Unidentified |
| A006 | Reverse | 0 | 0 | 35 | 0 | 90 | Unidentified |
| A007 | Forward | 0 | 0 | 40 | 37 | 87 | Unidentified |
| A008 | Reverse | 0 | 0 | 120 | 0 | 72 | Two-axis left |
| | | | | | | | outer wheel |
| A009 | Forward | 35 | 0 | 40 | 0 | 62 | Unidentified |
| A009 | Reverse | 0 | 0 | 0 | 110 | 50 | Unidentified |

Referring to Table 3 and Table 4, when the clustering degrees for respective wheel speed sensors 210 (i.e., clustering degrees for respective tire positions) are stored for the respective sensor IDs, the clustering degrees excluding the maximum clustering degree P1 and the second highest clustering degree P2 are processed as 0. While repeatedly performing the process of S11 described with reference to FIG. 4, the process for correcting a clustering degree for the sensor ID of which the corresponding tire position is not identified may be repeatedly performed. In this case, while storing the corrected clustering degrees in the memory 320 in S42 of FIG. 5B, the main controller 230 may correct the current clustering degree value with a sum of the previously stored clustering degree and the current clustering degree value instead of deleting the previously stored clustering degrees.

Table 5 expresses examples of updated clustering degrees for respective wheel speed sensors of the respective sensor IDs while repeatedly performing the process of S11 described with reference to FIG. 4.

TABLE 5
Secondarily corrected clustering degrees

| | | Clustering degrees | | | | | | |
|---|---|---|---|---|---|---|---|---|
| Sensor | Rotation | Front | Front | Rear | Rear | | | |
| ID | direction | left | right | right | left | RSSI | Recognition | Etc., |
| A001 | Forward | 120 | 0 | 0 | 0 | 40 | One-axis | |
| | | | | | | | left wheel | |
| A002 | Reverse | 0 | 100 | 0 | 0 | 30 | One-axis | |
| | | | | | | | right wheel | |
| A003 | Forward | 0 | 0 | 110 | 0 | 70 | Two-axis | |
| | | | | | | | left inner wheel | |
| A004 | Reverse | 0 | 0 | 160 | 0 | 65 | Three-axis | Sum of |
| | | | | | | | right inner wheel | previous |
| | | | | | | | | values |
| A005 | Forward | 0 | 0 | 35 | 165 | 55 | Two-axis | Sum of |
| | | | | | | | right outer wheel | previous |
| | | | | | | | | values |
| A006 | Reverse | 0 | 0 | 70 | 0 | 90 | Three-axis | Sum of |
| | | | | | | | left outer wheel | previous |
| | | | | | | | | values |
| A007 | Forward | 0 | 0 | 80 | 74 | 87 | Three-axis | Sum of |
| | | | | | | | left inner wheel | previous |
| | | | | | | | | values |
| A008 | Reverse | 0 | 0 | 120 | 0 | 72 | Two-axis | |
| | | | | | | | left outer wheel | |
| A009 | Forward | 70 | 0 | 80 | 0 | 62 | Three-axis | Sum of |
| | | | | | | | right outer wheel | previous |
| | | | | | | | | values |
| A009 | Reverse | 0 | 40 | 0 | 165 | 50 | Two-axis | Sum of |
| | | | | | | | right inner wheel | previous |
| | | | | | | | | values |

Referring to Table 4 and Table 5, the sensor IDs corresponding to the left wheel and the right wheel installed in the first axle 5a of the vehicle shown in FIG. 6A and the left outer wheel and the left inner wheel installed in the second axle 5b of the vehicle are identified according to the process for identifying a tire position using the first clustering degree. Accordingly, while repeatedly performing the process of S11 shown in FIG. 4, the process for identifying a position using a clustering degree may be omitted for the left wheel and the right wheel installed in the first axle 5a of the vehicle shown in FIG. 6A and the left outer wheel and the left inner wheel installed in the second axle 5b of the vehicle. On the contrary, regarding the other tire positions, the clustering degree is corrected as expressed in Table 5 so as to perform the process for identifying a tire position using a second clustering degree. In this process, the clustering degrees may be summed with the clustering degrees used to the first position identification, and may then be updated. The process for correcting a clustering degree increases discrimination of the clustering degrees P1 and P2 used to identification of tire positions.

Referring to FIG. 5A, when the process for correcting the clustering degrees P1 and P2 corresponding to the sensor ID of each state information collecting device 100 is completed, the main controller 330 identifies the tire position corresponding to the respective sensor IDs, that is, the respective state information collecting devices 100 based on at least one of the clustering degrees for respective wheel speed sensors 210 of the respective sensor IDs, and the tire rotation directions corresponding to the respective sensor IDs (S24). The respective tire positions and the sensor ID of the state information collecting device 100 identified to correspond to them are mapped on each other and are stored in the memory 320 (S25).

In S24, when there is a clustering degree that is equal to or greater than a threshold value (e.g., 100) from among the clustering degrees for respective wheel speed sensors 210 of the respective sensor IDs, and the tire rotation direction specified to the tire position of the wheel speed sensor 210 at which the corresponding clustering degree appears matches the tire rotation direction corresponding to the sensor ID, the main controller 330 may finally recognize the tire position of the wheel speed sensor 210 at which the corresponding clustering degree appears as tire position corresponding to the sensor ID. For example with reference to Table 4, the tire rotation direction estimated corresponding to the sensor ID A0001 is a forward direction, the clustering degree of the wheel speed sensor 210 of the front left wheel from among the clustering degrees corresponding to the sensor ID A0001 is equal to or greater than 100, and as shown in FIG. 6A, the tire rotation direction of the front left wheel according to a proceeding direction of the vehicle is specified to be a forward direction, so the state information collecting device 100 corresponding to the sensor ID A0001 may be identified to be positioned on the front left wheel.

In the present specification, the tire rotation direction is not a traveling direction of the vehicle, but is defined to be a forward direction and a reverse direction with respect to an output signal of the two-axis sensor 111 installed in the respective tires. An installing direction of the two-axis sensor 111 for each tire position is predefined for each vehicle, and the main controller 330 may specify the installing direction of the two-axis sensor 111 define for each tire position and the rotation direction of the tire from the traveling direction of the vehicle. Therefore, the main controller 330 may compare the tire rotation direction at each tire position specified in this way and the tire rotation direction (the tire rotation direction corresponding to the sensor ID) estimated by detecting the actual acceleration information from the state information collecting device 100, and may use the comparison result for identification of tire positions.

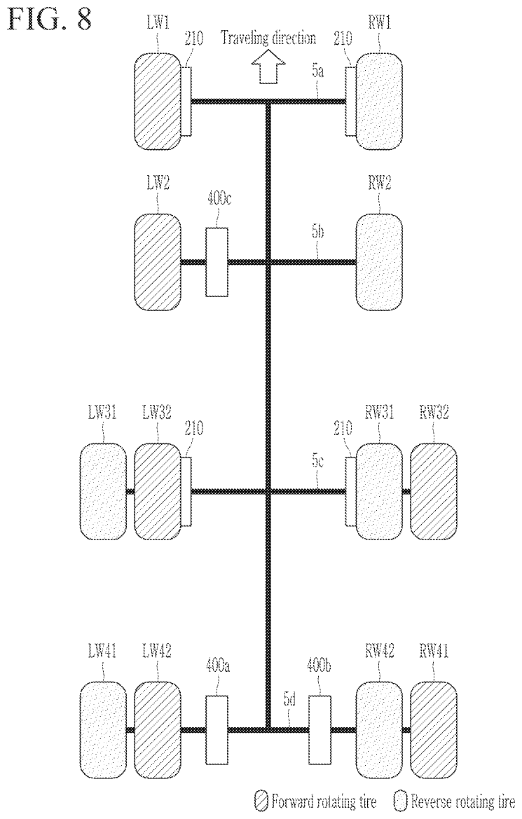

FIG. 7 shows a flowchart of a method for identifying a tire position by using signal receiving intensity in a tire monitoring system 10 according to an embodiment of the present invention. FIG. 8 shows an example of a vehicle to which a tire monitoring system according to an embodiment of the present invention is applied, describing a method described with reference to FIG. 7.

Referring to FIG. 7, the main controller 330 of the tire monitoring system 10 according to an embodiment of the present invention checks whether a plurality of receiving devices 400 are installed for one axle based on position information of the receiving device 400 (S50).

When a plurality of receiving devices 400 are installed for one axle, the tire position is identified for the corresponding axle. That is, the main controller 330 receives signal receiving intensities corresponding to the respective sensor IDs from a plurality of receiving devices 400 installed in the corresponding axle, and matches the sensor ID from the tire positions of the axle in which a plurality of receiving devices 400 are installed based on the signal receiving intensities corresponding to the respective sensor IDs and the tire rotation direction (S51).

For example, with reference to FIG. 8, first and second receiving devices 400a and 400b are installed in the fourth axle 5d of the vehicle. According to this, the main controller 330 matches the corresponding sensor ID from the tire positions (LW41, LW42, RW41, and RW42) installed in the fourth axle 5d.

The main controller 330 extracts the sensor IDs of which the corresponding tire rotation direction is a reverse direction from among the sensor IDs of which tire positions are not identified, and matches the sensor ID with the greatest signal receiving intensity in the first receiving device 400a and the outer wheel LW41 of dual wheels that is near the first receiving device 400a from among them. The main controller 330 extracts the sensor IDs of which the corresponding tire rotation direction is a forward direction from among the sensor IDs of which the tire position is not identified, and matches the sensor ID with the greatest signal receiving intensity in the first receiving device 400a and the inner wheel LW42 of dual wheels that is near the first receiving device 400a from among them.

The main controller 330 extracts the sensor IDs of which the corresponding tire rotation direction is a reverse direction from among the sensor IDs of which the tire position is not identified, and matches the sensor ID with the greatest signal receiving intensity in the second receiving device 400b and the inner wheel RW42 of dual wheels that is near the second receiving device 400b from among them. The main controller 330 extracts the sensor IDs of which the corresponding tire rotation direction is a forward direction from among the sensor IDs of which the tire position is not identified, and matches the sensor ID with the greatest signal receiving intensity in the second receiving device 400b and the outer wheel RW41 of dual wheels that is near the second receiving device 400b from among them.

Referring to FIG. 7, when the matching of the sensor ID on the tire positions of the axle in which a plurality of receiving devices 400 are installed is finished, the main controller 330 performs a sensor ID matching on the tire positions of the axle in which the receiving device 400 is individually installed. That is, the main controller 330 receives the signal receiving intensities corresponding to the respective sensor IDs from the receiving device 400 individually installed in the corresponding axle, and matches the sensor IDs and the tire positions of the axle in which the receiving device 400 is installed based on the signal receiving intensity corresponding to the sensor ID and the tire rotation direction in order of nearness to the receiving device 400 (S52).

For example with reference to FIG. 8, a third receiving device 400c is installed in the second axle 5b of the vehicle. Accordingly, the main controller 330 matches the sensor IDs and the tire positions LW2 and RW2 installed in the second axle 5b in order of nearness to the third receiving device 400c.

The main controller 330 extracts the sensor IDs of which the corresponding tire rotation direction is a forward direction from among the sensor IDs of which tire position is not identified, and matches the sensor ID with the greatest signal receiving intensity in the third receiving device 400c from among them and the left wheel LW2 that is near the third receiving device 400c. The main controller 330 extracts the sensor IDs of which the corresponding tire rotation direction is a reverse direction from among the sensor IDs of which the tire position is not identified, and matches the sensor ID with the greatest signal receiving intensity in the third receiving device 400c from among them and the right wheel RW2 installed in the same axle 5b as the third receiving device 400c.

Referring to FIG. 7, when the matching of the sensor IDs to the tire positions of the entire axles in which the receiving device 400 is installed is completed through the S51 and S52 (S53), the main controller 330 finishes the process for identifying a tire position using signal receiving intensity (S54).

FIG. 9 shows a flowchart of a method for identifying a tire position according to an automatic learning in a tire monitoring system 10 according to an embodiment of the present invention.

Referring to FIG. 9, when there is a tire position to which a corresponding sensor ID is not specified according to the process for identifying a tire position using a position information fluctuating pattern of the wheel speed sensors 210 and the process for identifying a tire position using signal receiving intensity of the receiving device 400, the main controller 330 of the tire monitoring system 10 according to an embodiment of the present invention may match the sensor ID and the corresponding tire positions in next order.

The main controller 330 matches the sensor ID and the tire position of the wheel speed sensor 210 indicating the maximum clustering degree on the sensor ID (S61) when there is a sensor ID with which the clustering degree calculated during the process for identifying a tire position using a position information fluctuating pattern of the wheel speed sensors 210 from among the sensor IDs of which the tire position is not specified is equal to or greater than a predetermined value (S60).

When there is an unidentified tire position, and there is a sensor ID of which a number of receiving times is equal to or greater than a predetermined value from among the registered sensor IDs in which the corresponding tire position is not specified (S62), the main controller 330 matches this and the unidentified tire position (S63).

When there is an unidentified tire position, and there is a sensor ID of which a number of receiving times is equal to or greater than a predetermined value (S64) from among new sensor IDs in which no corresponding tire position is specified, the main controller 330 matches it and the unidentified tire position (S65).

When there is an unidentified tire position (S66) after the above-noted process is performed, the main controller 330 maintains the sensor ID matched to the corresponding tire position (S67), and finishes identification of tire positions through auto learning (S68).

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10: tire monitoring system
100: state information collecting device
111: two-axis sensor
112: pressure sensor
113: temperature sensor
120: sensor controller
130: transmitter
200: wheel speed sensor assembly
210: wheel speed sensor
220: sensor ring
221: protrusion
300: monitoring device
310: receiver
320: memory
330: main controller
400: receiving device
410: receiver
420: sub-controller
5a, 5b, 5c, 5d: axle

1. A tire monitoring system comprising:
a state information collecting device installed in a first tire of a vehicle, and periodically transmitting unique identification information according to a rotation period of the first tire;
a plurality of wheel speed sensors of which position information is changed according to rotations of a plurality of second tires installed in the vehicle; and
a monitoring device for receiving the unique identification information from the state information collecting device, detecting position information of the respective wheel speed sensors according to a receiving time of the unique identification information for a predetermined time, and identifying a position of the first tire based on fluctuating patterns of position information of the respective wheel speed sensors detected according to the receiving time of the unique identification information.

2. The tire monitoring system of claim 1, wherein
the wheel speed sensors are respectively a wheel speed sensor in an anti-lock brake system of the corresponding tire.

3. The tire monitoring system of claim 2, wherein
position information of the respective wheel speed sensors is relative angle information with reference to a reference point.

4. The tire monitoring system of claim 1, wherein
the state information collecting device includes a two-axis sensor installed in the first tire and generating a sensing signal corresponding to acceleration information of the first tire,
the sensing signal includes an x-axis phase waveform and a z-axis phase waveform output from the two-axis sensor, and
the acceleration information includes phase difference information between the x-axis phase waveform and the z-axis phase waveform.

5. The tire monitoring system of claim 4, wherein
an installing direction of the two-axis sensor becomes different according to a position of the first tire, and
the monitoring device receives the acceleration information from the state information collecting device, estimates a rotation direction of the first tire from the acceleration information, and determines a position of the first tire based on a rotation direction of the first tire.

6. The tire monitoring system of claim 5, wherein
regarding the two-axis sensor, an installing direction when the first tire corresponds to a left wheel is opposite to an installing direction when the first tire corresponds to a right wheel, and an installing direction when the first tire corresponds to an inner wheel configuring dual wheels is opposite to an installing direction when the first tire corresponds to an outer wheel configuring the dual wheels.

7. The tire monitoring system of claim 6, wherein
regarding a rotation direction of the first tire estimated from the acceleration information while the vehicle goes in a first direction, a case in which the first tire corresponds to a left wheel and a case in which the first tire corresponds to a right wheel are estimated to be in opposite directions to each other, and a case in which the first tire corresponds to an inner wheel configuring dual wheels and a case in which the first tire corresponds to an outer wheel configuring the dual wheels are estimated to be in opposite directions to each other.

8. The tire monitoring system of claim 1, wherein
the monitoring device calculates clustering degrees for the respective wheel speed sensors through a statistical analysis on position information of the respective wheel speed sensors detected according to a receiving time of the unique identification information, and identifies a position of the first tire based on the clustering degree and the tire positions defined for the wheel speed sensors.

9. The tire monitoring system of claim 1, further comprising
a receiving device for receiving a signal from a plurality of state information collecting devices including the state information collecting device in a wireless way,
wherein the monitoring device identifies a position of the first tire based on signal receiving intensity in the receiving device for the state information collecting devices when the position of the first tire is not identified based on a fluctuating pattern of position information of the wheel speed sensors.

10. A method for identifying a tire position of a tire monitoring system installed in a vehicle comprising:
receiving unique identification information from a state information collecting device of the first tire according to a rotation period of a first tire installed in the vehicle;
when receiving the unique identification information, detecting position information on a plurality of wheel speed sensors of which position information is changed according to respective rotations of a plurality of second tires installed in the vehicle;
repeating the receiving of the unique identification information and the detecting of position information for a predetermined time; and
identifying a position of the first tire based on a fluctuating pattern of position information detected for the respective wheel speed sensors for the predetermined time.

11. The method of claim 10, wherein
the wheel speed sensors are respectively a wheel speed sensor in an anti-lock brake system of a corresponding tire, and
position information of the respective wheel speed sensors is relative angle information with reference to a reference point.

12. The method of claim 10, further comprising:
receiving acceleration information of the first tire detected from the state information collecting device through a two-axis sensor;
estimating a rotation direction of the first tire based on the acceleration information; and
identifying a position of the first tire based on the rotation direction,
wherein an installing direction of the two-axis sensor is changed according to a position of the first tire, and
the rotation direction is differently estimated according to an installing direction of the two-axis sensor.

13. The method of claim 12, wherein
regarding the rotation direction, a case in which the first tire corresponds to a left wheel and a case in which the first tire corresponds to a right wheel are estimated to be in opposite directions to each other, and a case in which the first tire corresponds to an inner wheel configuring dual wheels and a case in which the first tire corresponds to an outer wheel configuring the dual wheels are estimated to be in opposite directions to each other.

14. The method of claim 10, wherein
the identifying includes:
calculating clustering degrees for the respective wheel speed sensors through a statistical analysis on position information detected for the respective wheel speed sensors for the predetermined time; and
identifying a position of the first tire based on the clustering degree and the tire positions defined for the respective wheel speed sensors.

15. The method of claim 10, wherein
the vehicle further includes a receiving device for receiving a signal from a plurality of state information collecting devices including the state information collecting device in a wireless way, and
the method further includes:
when the position of the first tire is not identified based on a fluctuating pattern of position information of the respective wheel speed sensors, detecting signal receiving intensity in the receiving device for the state information collecting devices; and
identifying a position of the first tire based on the signal receiving intensity in the receiving device for the respective state information collecting devices.
